(19) United States
(12) Patent Application Publication
(10) Pub. No.: US 2006/0232652 A1
(43) Pub. Date: Oct. 19, 2006

(54) Liquid ejection apparatuses, method for forming dots, method for forming identification code, and method for manufacturing electro-optic devices

(76) Inventor: Hirotsuna Miura, Suwa-shi (JP)

Correspondence Address: HARNESS, DICKEY & PIERCE, P.L.C., P.O. BOX 828, BLOOMFIELD HILLS, MI, 48303, US

(21) Appl. No.: 11/390,977

(22) Filed: Mar. 28, 2006

(30) Foreign Application Priority Data
Mar. 29, 2005 (JP) 2005-096386

(51) Int. Cl. B41J 2/01

(52) U.S. Cl. 347/102

(57) ABSTRACT

A liquid ejection apparatus includes an ejecting portion that ejects a liquid droplet containing dot forming material onto a dot forming section defined on an ejection target surface. A radiating portion radiates an energy beam onto the ejection target surface for at least partially suppressing spreading of the liquid droplet in a wet state beyond the corresponding dot forming section. That is, by drying the liquid droplet, the shape of a dot is adjusted with improved accuracy.

### CROSS-REFERENCE TO RELATED APPLICATIONS

This application is based upon and claims the benefit of priority from prior Japanese Patent Application No. 2005-096386, filed on Mar. 29, 2005, the entire contents of which are incorporated herein by reference.

### BACKGROUND OF THE INVENTION

The present invention relates to liquid ejection apparatuses, methods for forming dots, methods for forming an identification code, and methods for manufacturing electro-optic devices.

Typically, an electro-optic device such as a liquid crystal display and an organic electroluminescence display (an organic EL display) includes a transparent glass substrate (hereinafter, simply referred to as a substrate) for displaying an image. An identification code (which is, for example, a two-dimensional code) is formed on the substrate for the purpose of quality control and production management. The identification code represents encoded product information of the substrate including the name of the manufacturer and the product number. The identification code is formed by dots (defined by, for example, color films or recesses) that have recognizable shapes and thus reproduce the encoded information. The dots are provided in selected ones of a number of aligned dot forming sections. (data cells). The dots as a whole define a dot pattern that represents the encoded product information.

As methods for forming an identification code, a laser sputtering method and a waterjet method have been proposed (see Japanese Laid-Open Patent Publication Nos. 11-77340 and 2003-127537). Specifically, in the laser sputtering method, an identification code is formed through sputtering of a metal foil involving radiation of laser beams onto the metal foil. In the waterjet method, water containing abrasive is ejected onto a substrate and thus marks the identification code on the substrate.

However, in the laser sputtering method, in order to form the identification code in accordance with a desired size, the distance between the metal foil and a substrate must be set to several to several tens of micrometers. Thus, the opposing surfaces of the metal foil and the substrate must be precisely formed to be flat and spaced from each other by a distance adjusted accurately in the order of micrometers. As a result, the laser sputtering method is applicable only to limited types of substrates, or cannot be used widely for general substrates. Further, in the waterjet method, water, dust, or abrasive is splashed onto the substrate when forming the code, leading to contamination of the substrate.

To solve these problems, an inkjet method has been focused on as an alternative. In the inkjet method, droplets of liquid containing metal particles are ejected by a liquid ejection apparatus. The liquid droplets are then dried for forming dots that define the identification code. The inkjet method is thus applicable to a wider range of substrates and prevents contamination of the substrate in formation of the identification code.

Since the dots are effectively formed in correspondence with the size of each droplet by the inkjet method, the inkjet method is used for manufacturing a color filter or a light emission element provided in a pigment area of the liquid crystal display or the organic EL display. Specifically, to form the color filter, liquid droplets containing different color layer forming materials are ejected onto a color layer formation area and then dried. To form the light emission element, liquid droplets containing light emission layer material are ejected onto a light emission element formation area and then dried. This makes it unnecessary to employ a mask for forming the dots or perform a photolithography step for forming the mask. The productivity for forming the dots is thus improved.

However, the data cells, the color layer formation area, and the light emission element formation area may have various shapes, such as oval shaped or rectangular shapes, depending on the use of these components. Therefore, the inkjet method may cause the following problem.

That is, after having been received by the dot forming sections, the liquid droplets spread wet in the dot forming sections until the droplets are fixed in substantially semispherical shapes as dots. In this state, some of the dots may be provided in a state spreading beyond the corresponding dot forming sections.

To solve this problem, a wall that repels the liquid droplet may be arranged to entirely encompass each of the dot forming sections. However, since an additional patterning step must be performed for forming such walls, the total number of the manufacturing steps of the dots increases.

### SUMMARY

Accordingly, it is an objective of the present invention to provide a liquid ejection apparatus, a method for forming dots, a method for forming an identification code, and a method for manufacturing electro-optic devices, in which the shape of a dot formed through drying of a liquid droplet can be adjusted with improved reliability.

According to a first aspect of the invention, a liquid ejection apparatus is provided. An ejecting portion ejects a liquid droplet containing a dot forming material onto a dot forming section defined on an ejection target surface. A radiating portion radiates an energy beam onto the ejection target surface for at least partially suppressing spreading of the liquid droplet in a wet state after the droplet has been received by the dot forming section.

According to a second aspect of the invention, a method for forming a dot is provided. A liquid droplet containing a dot forming material is ejected to an ejection target surface. An energy beam is radiated onto the ejection target surface for at least partially suppressing spreading of the liquid droplet in a wet state on the ejection target surface. A dot is formed by drying the liquid droplet on the ejection target surface.

### BRIEF DESCRIPTION OF THE DRAWINGS

The invention, together with objects and advantages thereof, may best be understood by reference to the following description of the presently preferred embodiments together with the accompanying drawings in which:

FIG. 1 is a front view showing a liquid crystal display module;

FIG. 2 is a front view showing an identification code formed on the backside of the liquid crystal display module of FIG. 1;

FIG. 3 is a side view showing the identification code of FIG. 2;

FIG. 4 is a view for explaining the configuration of the identification code of FIG. 2;

FIG. 5 is a perspective view showing a liquid ejection apparatus according to a first embodiment of the present invention;

FIG. 6 is a perspective view showing an ejection head of the liquid ejection apparatus of FIG. 5, as viewed from below;

FIG. 7 is a cross-sectional view showing the ejection head of FIG. 6 in a state a liquid droplet is being ejected;

FIG. 8 is a plan view showing a beam spot provided by the liquid ejection apparatus of FIG. 5;

FIG. 9 is a plan view showing a first beam spot provided on a droplet;

FIG. 10 is a plan view showing a second beam spot provided on a droplet;

FIG. 11 is a block diagram representing an electric circuit of the liquid ejection apparatus of FIG. 5;

FIG. 12 is a timing chart representing operational timings of a piezoelectric element of FIG. 7 and those of a semiconductor laser of FIG. 7;

FIG. 13 is a cross-sectional view showing a laser head according to a second embodiment of the present invention;

FIG. 14 is a cross-sectional view showing the laser head of FIG. 13 for explaining operation of the laser head;

FIG. 15 is a block diagram representing an electric circuit of a liquid ejection apparatus having the laser head of FIG. 13;

FIG. 16 is a timing chart representing operational timings of a piezoelectric element of FIG. 13 and those of a semiconductor laser of FIG. 13;

FIG. 17 is a perspective view showing a color filter substrate according to a third embodiment of the present invention;

FIG. 18 is a side view showing the color filter substrate of FIG. 17 for explaining manufacturing steps of the substrate;

FIG. 19 is a cross-sectional view showing the color filter substrate of FIG. 17; and

FIG. 20 is a plan view showing a modified example of the beam spot.

### DETAILED DESCRIPTION OF THE PREFERRED EMBODIMENTS

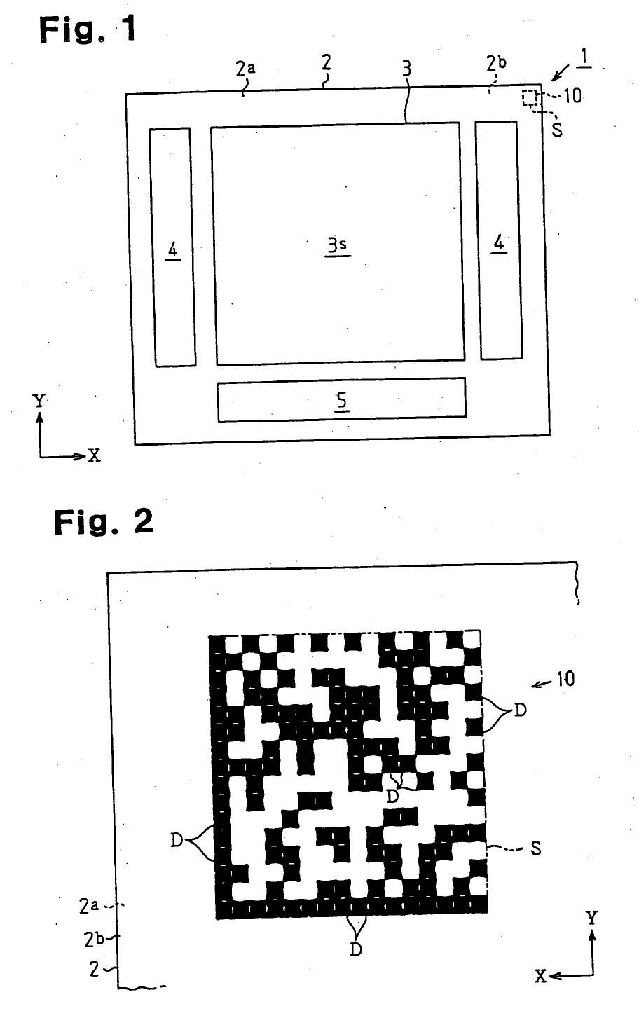

A first embodiment of the present invention will now be described with reference to FIGS. 1 to 12.

First, a liquid crystal display, or an electro-optic device, which includes an identification code formed by a liquid ejection apparatus according to the present invention, will be explained.

As shown in FIG. 1, a liquid crystal display module 1, which is incorporated in the liquid crystal display, includes a transparent glass substrate 2 (hereinafter, simply referred to as a substrate 2). The substrate 2 is light-transmittable and has a rectangular shape. In the first embodiment, referring to FIG. 1, the longitudinal direction (the rightward or leftward direction as viewed in the drawing) of the substrate 2 is defined as direction X and a direction perpendicular to direction X is defined as direction Y.

A rectangular display portion 3s is formed substantially at the center of a surface 2a of the substrate 2. A color filter substrate 3 (see FIG. 17) is bonded with the display portion 3s. Liquid crystal molecules are sealed between the color filter substrate 3 and the substrate 2.

A scanning line driver circuit 4 and a data line driver circuit 5 are arranged outside the display portion 3s. The scanning line driver circuit 4 generates scanning signals and the data line driver circuit 5 generates data signals. In correspondence with the signals, the liquid crystal display module 1 controls the orientations of the liquid crystal molecules. The liquid crystal display module 1 modulates area light emitted by a non-illustrated illumination device in accordance with the orientations of the liquid crystal molecules. In this manner, a desired image is displayed on the display portion 3s.

A backside 2b of the substrate 2 serving as an ejection target surface is lyophilic with respect to liquid droplets Fb, which will be later described. As viewed in FIG. 1, the identification code 10 of the liquid crystal display module 1 is formed at a top right corner of the backside 2b of the substrate 2. The identification code 10 is defined by a plurality of dots D provided in a code formation area S, as shown in FIG. 2. As shown in FIG. 4, the code formation area S is virtually divided into 256 data cells C (hereinafter, referred to simply as cells C) that are aligned in accordance with 16 lines by 16 rows. More specifically, in the first embodiment, the code formation area S is shaped as a square each side of which is 2.24 mm long. Each of the cells C is formed as a square each side of which is 140 μm long. The dots D are formed in selected ones of the cells C. The distribution pattern of the dots D defines the identification code 10 that identifies the product number or the lot number of the liquid crystal display module 1.

In this embodiment, the dimension of each side of the cell C is referred to as a cell size Ra. Further, each of the occupied cells C, which contains the dot D, is defined as a black cell C1. Each of the empty cells C is defined as a blank cell C0. As viewed in FIG. 4, the columns of the cells C are consecutively numbered as a first column to a sixteen column from the left to the right, or in a direction opposite to direction X. In the same manner, the rows of the cells C are consecutively numbered as a first row to a sixteenth row from up to down, or in a direction opposite to direction Y.

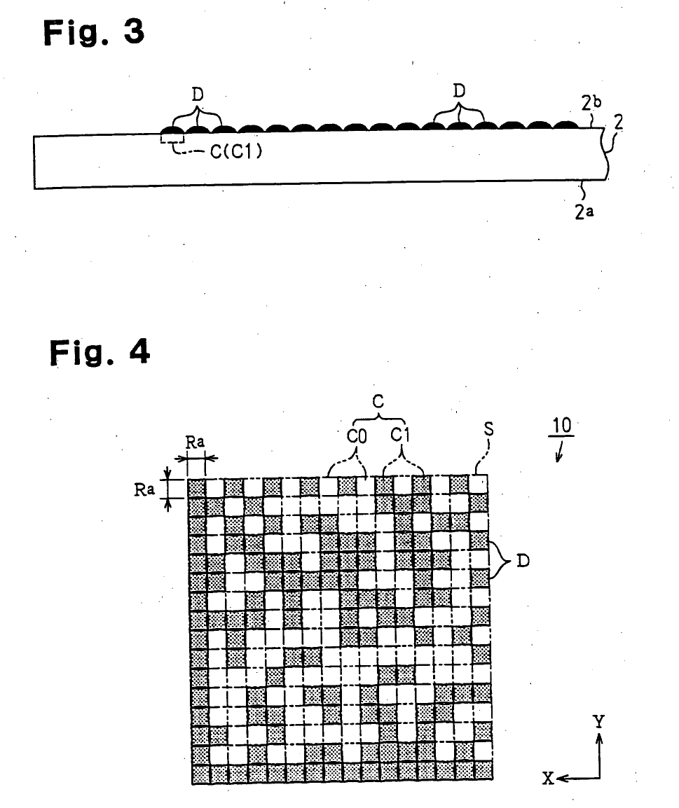

Referring to FIG. 2, each of the dots D has a rectangular shape corresponding to the shape of each black cell C1 as viewed from above. With reference to FIG. 3, each dot D has a semispherical shape and is bonded with the substrate 2 as viewed from beside. The dots D are formed by an inkjet method.

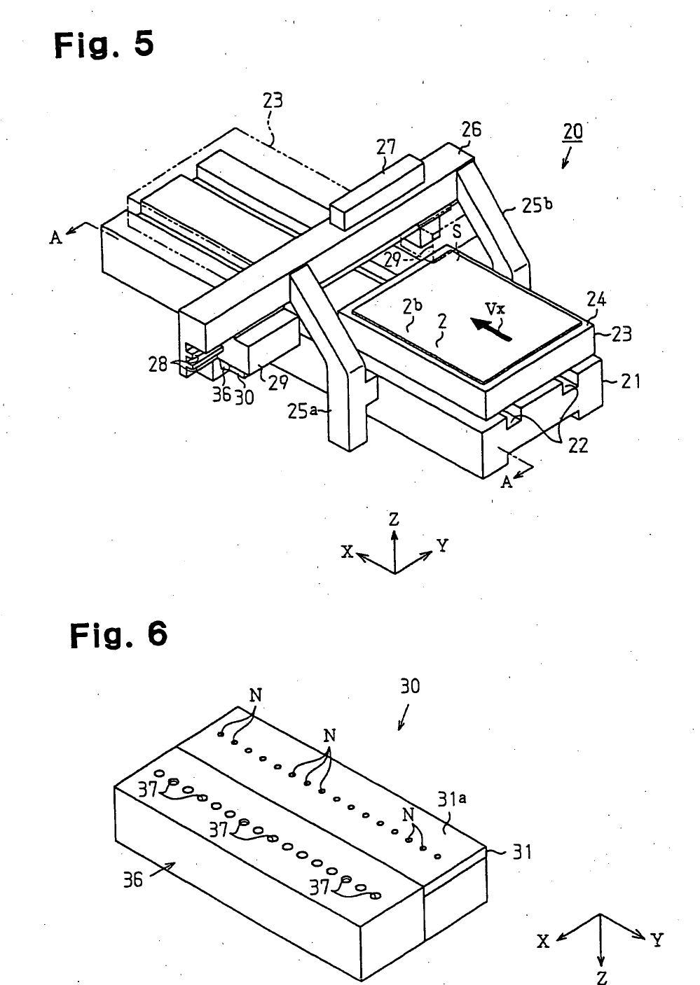

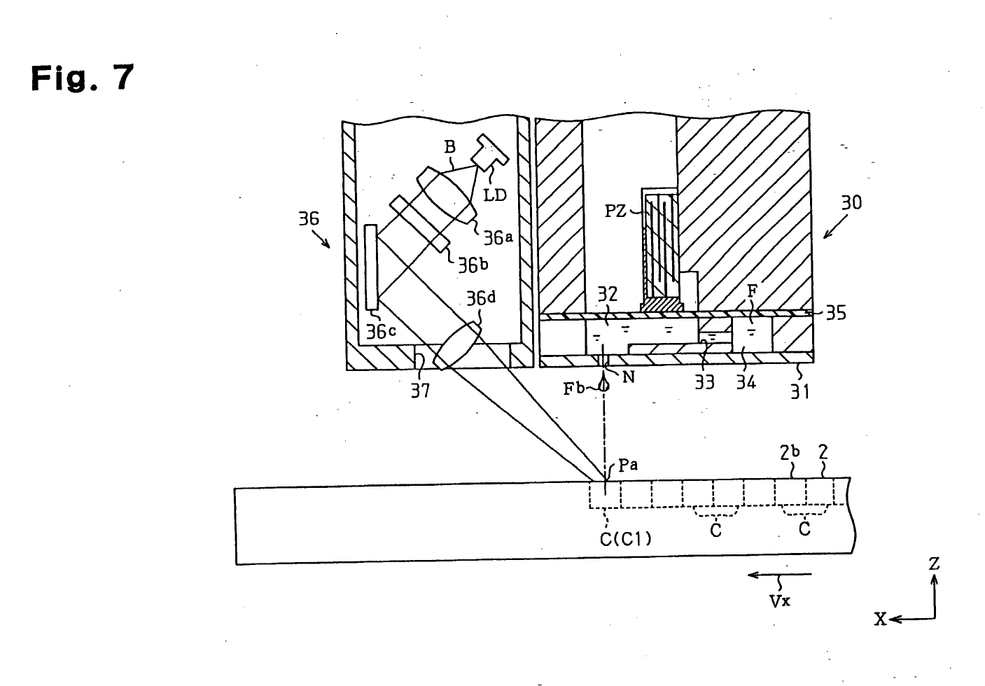

That is, a liquid ejection apparatus 20 of FIG. 5 ejects the droplets Fb from ejection nozzles N, which are shown in FIGS. 6 and 7, onto the corresponding cells C (black cells C1). Each of the droplets Fb contains metal particles as dot forming material, which is, for example, nickel particles. The dots D are provided by drying the droplets Fb that have been received by the corresponding cells C (black cells C1) and baking the metal particles.

The liquid ejection apparatus 20, which is used for forming the identification code 10, will now be described in detail. FIG. 5 is a perspective view showing the liquid ejection apparatus 20.

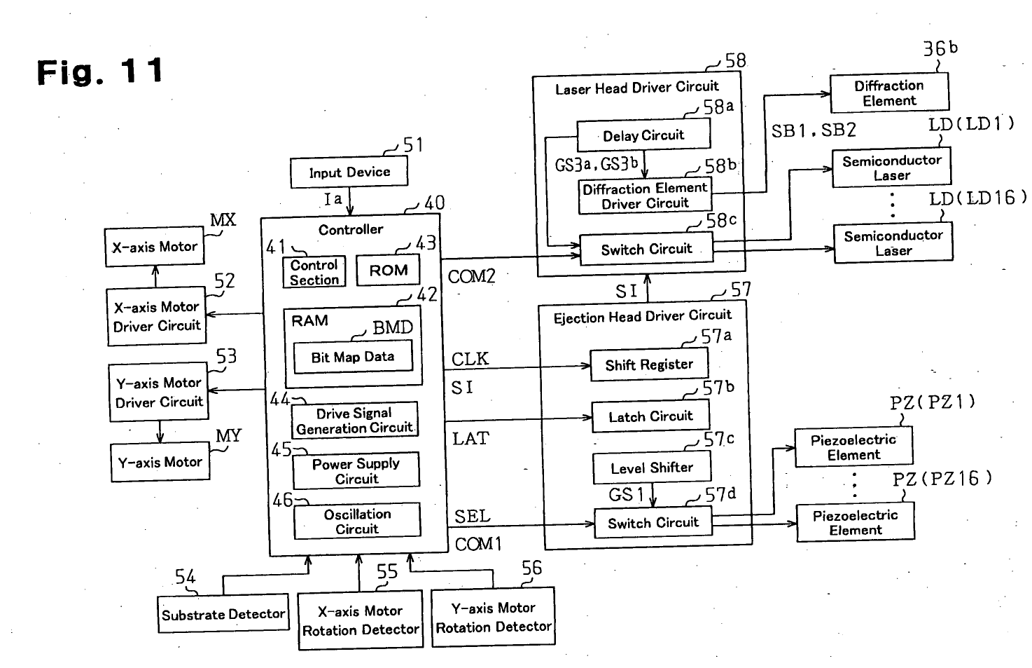

As shown in FIG. 5, the liquid ejection apparatus 20 includes a parallelepiped base 21 and a substrate stage 23. A pair of guide grooves 22 extend in the upper surface of the base 21 and along the entire length of the base 21. The substrate stage 23 is supported by the guide grooves 22 through a linear movement mechanism (not shown). The substrate 2 is mounted on the substrate stage 23. The longitudinal direction of the base 21 and the movement direction of the substrate stage 23 correspond to direction X. The linear movement mechanism of the substrate stage 23 is a threaded type that has threaded shafts, or drive shafts, extending along the guide grooves 22 in direction X and ball nuts engaged with the threaded shafts. The drive shafts are driven by an x-axis motor MX (see FIG. 11), which is formed by a stepping motor. In response to a drive signal corresponding to a predetermined number of steps, which is input to the x-axis motor MX, the x-axis motor MX is rotated in a forward direction or a reverse direction. This moves the substrate stage 23 at a predetermined transport speed Vx in direction X or the direction opposite to direction X by a distance corresponding to the number of steps.

In the first embodiment, when the substrate stage 23 is arranged at the position indicated by the solid lines of FIG. 5, it is defined that the substrate stage 23 is located at a proceed position. When the substrate stage 23 is arranged at the position indicated by the double-dotted broken lines of FIG. 5, it is defined that the substrate stage 23 is located at a return position.

A suction type substrate chuck mechanism (not shown) is arranged on the upper surface of the substrate stage 23, which serves as a mounting surface 24. When the substrate 2 is mounted on the mounting surface 24 with the backside 2b (the code formation area S) facing upward, the backside 2b is positioned with respect to the mounting surface 24 in such a manner that the first column of the cells C are arranged at a proceeding position. In this state, the substrate stage 23 is moved forward at the transport speed Vx in direction X.

A pair of supports 25a, 25b are arranged at opposing sides of the base 21 in direction Y and extend upward. A guide member 26 is supported by the supports 25a, 25b and extends along direction Y. The longitudinal dimension of the guide member 26 is greater than the dimension of the substrate stage 23 in direction Y. An end of the guide member 26 projects outwardly with respect to the support 25a. A maintenance unit (not shown) for wiping and washing a nozzle surface 31a (FIG. 6) of an ejection head 30 is provided immediately below the projecting end of the guide member 26.

A tank 27 is formed on the upper surface of the guide member 26 and retains functional liquid F (FIG. 7) prepared by dispersing the metal particles. The functional liquid F is thus introduced into the ejection nozzles N of the ejection head 30.

A pair of upper and lower guide rails 28 are formed below the guide member 26 and extend along direction Y. A carriage 29 is supported by the guide rails 28 in such a manner that the carriage 29 is reciprocated along the guide rails 28. Reciprocation of the carriage 29 is caused by a threaded type linear movement mechanism including a threaded shaft (a drive shaft) and a ball nut. The drive shaft of the mechanism extends along the guide rails 28 and the ball nut is engaged with the threaded shaft. The drive shaft is connected to a y-axis motor MY (see FIG. 11), which is formed by a stepping motor.

In the first embodiment, the carriage 29 is reciprocated between the position indicated by the corresponding solid lines of FIG. 5 (in the vicinity of the support 25a) and the position indicated by the corresponding double-dotted broken lines of FIG. 5 (in the vicinity of the support 25b).

The ejection head 30 is formed on the lower surface of the carriage 29, referring to FIG. 5. FIG. 6 is a perspective view showing the ejection head 30 with the lower surface of the ejection head 30, which opposes the substrate stage 23, faced upward. FIG. 7 is a cross-sectional view showing the interior of the election head 30.

As shown in FIG. 7, a nozzle plate 31 is formed on the lower surface of the ejection head 30. The nozzle surface 31a is defined by the lower surface of the nozzle plate 31. Sixteen ejection nozzles N are defined in the nozzle surface 31a for ejecting the droplets Fb. The ejection nozzles N are aligned in a single line extending in direction Y and equally spaced.

Each of the ejection nozzles N is defined by a circular hole having a size equal to the cell size Ra. The ejection nozzles N are opposed to the corresponding cells C when the code formation area S of the substrate 2 is linearly reciprocated in direction X. As shown in FIG. 7, each ejection nozzle N extends vertically to the nozzle surface 31a. In other words, each ejection nozzle N extends in direction Z, which is defined by a normal line of the backside 2b of the substrate 2.

Referring to FIG. 7, cavities 32, or pressure chambers, are defined in the ejection head 30 and communicate with the corresponding ejection nozzles N. A communication bore 33 extends from each of the cavities 32 and communicate with a single supply line 34, which communicates with the tank 27. Thus, the functional liquid F is introduced from the tank 27 to the cavities 32. Each of the cavities 32 supplies the functional liquid F to the corresponding one of the ejection nozzles N.

The ejection head 30 includes oscillation plates 35, each of which defines the corresponding cavity 32. Each of the oscillation plates 35 is formed by, for example, a polyphenylene sulfide film (PPS) having a thickness of approximately 2 μm. Each oscillation plate 35 oscillates in direction Z so as to selectively increase and decrease the volume of the corresponding cavity 32.

Sixteen piezoelectric elements PZ are provided adjacent to the oscillation plates 35 and in correspondence with the ejection nozzles N. Each of the piezoelectric elements PZ selectively contracts and extends in correspondence with a piezoelectric element drive signal COM1 (see FIG. 11). This oscillates the corresponding oscillation plate 35 in direction Z.

As the piezoelectric element PZ contracts, the volume of the corresponding cavity 32 increases. As the piezoelectric element PZ extends, the volume of the cavity 32 decreases. Thus, through such contraction and extension of the piezoelectric element PZ, the functional liquid F is ejected from the corresponding nozzle N as the droplet Fb by the amount corresponding to the decreased volume of the cavity 32. After having been received by the backside 2b of the substrate 2, the ejected droplet Fb spreads wet radially outward on the backside 2b, which is lyophilic, while defining a semispherical shape.

In the first embodiment, a position on the backside 2b of the substrate 2 and immediately below each of the nozzles N, or a position at which a droplet Fb is located immediately after having been received by the backside 2b of the substrate 2, is defined as a droplet receiving position Pa.

As shown in FIG. 5, a laser head 36, or a laser radiating portion, is arranged below the carriage 29 and at the side of the ejection head 30 located forward with respect to direction X.

As shown in FIGS. 6 and 7, sixteen radiation ports 37 are defined in the lower surface of the laser head 36 in correspondence with the sixteen ejection nozzles N.

Referring to FIG. 7, a semiconductor laser array LD is provided in the laser head 36 and includes sixteen semiconductor lasers L corresponding to the sixteen radiation ports 37. Each of the semiconductor lasers L radiates a laser beam B, or an energy beam. In the first embodiment, the laser beam B is a coherent light having a wavelength (for example, 800 nm) that evaporates dispersion medium of each droplet Fb and bakes the metal particles of the droplet Fb.

In the laser head 36, a collimator 36a, a diffraction element 36b, a reflective mirror 36c, and an objective lens 36d are arranged for each semiconductor laser L in this order from the side corresponding to the semiconductor lasers L to the side corresponding to the radiation ports 37. The collimator 36a forms a parallel light flux from a laser beam B that has been radiated by any one of the semiconductor lasers L. The parallel light flux is sent to the diffraction element 36b. The diffraction element 36b is mechanically or electrically activated in response to a pinning spot signal SB1 (see FIG. 11) and a drying intensity signal SB2 (FIG. 11). The diffraction element 36b modulates the phase of the laser beam B, which has been sent from the diffraction element 36b, in a prescribed manner. The reflective mirror 36c reflects and guides the laser beam B from the diffraction element 36b to the objective lens 36d. The objective lens 36d gathers the laser beam B reflected by the reflective mirror 36c and focally radiates the laser beam B onto the corresponding droplet receiving position Pa.

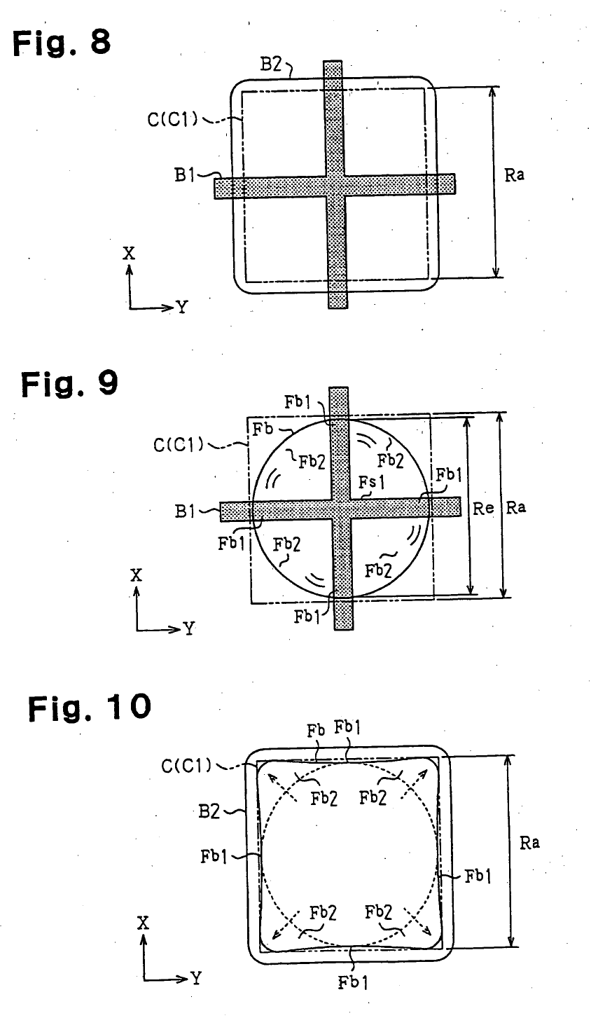

By activating the diffraction element 36b in correspondence with the pinning intensity signal SB1 and the drying intensity signal SB2, a pinning spot B1, or a first beam spot, and a drying spot B2, or a second beam spot, are defined at each of the droplet receiving positions Pa, with reference to FIG. 8. The pinning spot B1 has a crossed shape and includes a belt-like section extending in direction X and a belt-like section extending in direction Y. Each of the belt-like sections is slightly longer than the cell size Ra. The drying spot B2 covers the entire portion of each cell C (black cell C1).

In the first embodiment, the laser head 36 is constructed as the optical system having the collimator 36a, the diffraction element 36b, the reflective mirror 36c, and the objective lens 36d. However, the laser head 36 may be formed by any suitable optical system other than the aforementioned one as long as the two types of laser beam cross sections (the pinning spot B1 and the drying spot B2) are provided. For example, an optical system having a mask and a diffraction grating may be employed as the laser head 36.

After each droplet Fb has reached the corresponding droplet receiving position Pa, the outer diameter of the droplet Fb increases. Referring to FIG. 9, when the outer diameter of the droplet Fb reaches a predetermined value slightly smaller than the cell size Ra, or a radiation diameter Re, the laser beam B defining the pinning spot B1 is radiated onto the droplet Fb. The pinning spot B1 covers suppressing portions Fb1 and a radiated portion Fs1. Each of the suppressing portions Fb1 corresponds to an outer end portion of the droplet Fb located closest to the outline of the black cell C1. The radiated portion Fs1 is defined by a cross-shaped area in the droplet Fb including the suppressing portions Fb1. The functional liquid F is thus dried in the suppressing portions Fb1 and the radiated portion Fs1 by the pinning spot B1 and fixed to the cell C.

In this manner, the pinning spot B1 prevents the droplet Fb from spreading radially outward by the suppressing portions Fb1, thus containing the droplet Fb in the black cell C1. In other words, the pinning spot B1 performs pinning of the droplet Fb.

The remaining portions of the droplet Fb, which are not covered by the pinning spot B1, continuously spread wet in radial outward directions, which are indicated by the broken arrows of FIG. 10, due to the lyophilic property of the backside 2b of the substrate 2. The degree of such spreading is maximized at projected portions Fb2 that are most spaced from the adjacent suppressing portions Fb1, or intermediate portions between the adjacent suppressing portions Fb1.

As illustrated in FIG. 10, the laser beam B defining the drying spot B2 is radiated onto the droplet Fb when each of the projected portions Fb2 contacts the outline of the black cell C1 in the vicinity of the corresponding corners of the black cell C1. The drying spot B2 covers the entire portion of the droplet Fb, the shape of which corresponds to the outline of the black cell C1. The droplet Fb is thus dried and baked as a whole.

That is, by drying and baking the droplet Fb as a whole in the black cell C1, the drying spot B2 forms a dot D having a shape corresponding to the outline of the black cell C1.

In the first embodiment, the time from when excitement of a piezoelectric element PZ is started to when the outer diameter of the corresponding droplet Fb reaches the radiation diameter Re on the substrate 2, or radiation of the laser beam B defining the pinning spot B1 is started, is defined as a first standby time T1. The time from when excitement of the piezoelectric element PZ is started to when the projected portions Fb2 of the droplet Fb contact the outline of the corresponding black cell C1, or radiation of the laser beam B defining the drying spot B2 is started, is defined as a second standby time T2. In this embodiment, the first and second standby times T1, T2 have been measured by monitoring the droplets Fb using a super-high-speed camera or the like and.

The electrical configuration of the liquid ejection apparatus 20, which is constructed as above-described, will be explained with reference to FIG. 11.

Referring to FIG. 11, a controller 40 includes a control section 41 defined by, for example, a CPU, a RAM 42, and a ROM 43. The RAM 42 is defined by a DRAM and an SRAM and stores various data. The ROM 43 stores different control programs. The controller 40 also includes a drive signal generation circuit 44, a power supply circuit 45, and an oscillation circuit 46. The drive signal generation circuit 44 generates the piezoelectric element drive signal COM1. The power supply circuit 45 produces the laser drive signal COM2. The oscillation circuit 46 generates a clock signal CLK for synchronizing different drive signals.

In the controller 40, the control section 41, the RAM 42, the ROM 43, the drive signal generation circuit 44, the power supply circuit 45, and the oscillation circuit 46 are connected together through a non-illustrated bus.

An input device 51 is connected to the controller 40. The input device 51 includes manipulation switches such as a start switch and a stop switch. When each of the switches is manipulated, a manipulation signal is generated and input to the controller 40 (the control section 41). The input device 51 provides an image of the identification code 10 to the controller 40 as a prescribed form of code formation data Ia. The identification code 10 is defined by a two-dimensional code that is formed by a known method and represents identification data of the substrate 2 including the product number or the lot number. In accordance with the code formation data Ia and a control program (for example, an identification code formation program) stored in the ROM 43, the controller 40 performs a transport procedure for transporting the substrate 2 by moving the substrate stage 23 and a liquid ejection procedure by exciting selected ones of the piezoelectric elements PZ of the ejection head 30. Further, in accordance with the identification code formation program, the controller 40 performs a drying and baking procedure for drying and baking the droplets Fb by operating the semiconductor lasers L.

More specifically, the control section 41 performs a prescribed development procedure on the code formation data Ia of the input device 51. This produces bit map data BMD that indicates whether or not a droplet Fb must be ejected onto each of the cells C defined on a two-dimensional code formation plane (the code formation area S). The bit map data BMD is then stored in the RAM. The bit map data BMD is defined by 16×16-bit data generated in correspondence with the cells C, which are provided in 16 rows by 16 columns. That is, in accordance with the value (0 or 1) of each bit, the corresponding piezoelectric element PZ is selectively excited (ejection of a droplet Fb is selectively performed).

Also, the control section 41 subjects the code formation data Ia of the input device 51 to a development procedure that is different from the development procedure for the bit map data BMD. This produces waveform data of the piezoelectric element drive signal COM 1 that meets the conditions for forming the identification code 10. The waveform data is output to the drive signal generation circuit 44 and then stored in a non-illustrated waveform memory. The drive signal generation circuit 44 converts the waveform data, which is digital data, to an analog signal. The analog signal is then amplified, thus providing a corresponding piezoelectric element drive signal COM1.

Subsequently, the control section 41 serially transfers the bit map data BMD to an ejection head driver circuit 57 (a shift register 57a) as ejection control data SI, synchronously with the clock signal CLK of the oscillation circuit 46. The control section 41 then outputs the latch signal LAT for latching the ejection control data SI.

Further, synchronously with the clock signal CLK of the oscillation circuit 46, the control section 41 sends the piezoelectric drive signal COM1 to the ejection head driver circuit 57 (a switch circuit 57d). The control section 41 also provides a select signal SEL to the ejection head driver circuit 57 (the switch circuit 57d) for selecting the piezoelectric element drive signal COM1. The selected piezoelectric element drive signal COM1 is sent to the corresponding piezoelectric element PZ (PZ1 to PZ16).

Referring to FIG. 11, an x-axis motor driver circuit 52 is connected to the controller 40. The controller 40 thus sends an x-axis motor drive signal to the x-axis motor driver circuit 52. In response to the x-axis motor drive signal, the x-axis motor driver circuit 52 rotates the x-axis motor MX in a forward or reverse direction. The x-axis motor MX operates to reciprocate the substrate stage 23. For example, if the x-axis motor MX rotates in the forward direction, the substrate stage 23 moves in direction X. If the x-axis motor MX rotates in the reverse direction, the substrate stage 23 moves in the direction opposite to direction X.

A y-axis motor driver circuit 53 is connected to the controller 40. The controller 40 thus sends a y-axis motor drive signal to the y-axis motor driver circuit 53. In response to the y-axis motor drive signal, the y-axis motor driver circuit 53 rotates the y-axis motor MY in a forward or reverse direction. The y-axis motor MY operates to reciprocate the carriage 29. For example, if the y-axis motor MY rotates in the forward direction, the carriage 29 moves in direction Y. If the y-axis motor MY rotates in the reverse direction, the carriage 29 moves in a direction opposite to direction Y.

A substrate detector 54 is connected to the controller 40. The substrate detector 54 detects an end of the substrate 2. Through the substrate detector 54, the controller 40 calculates the position of the substrate 2 that is moving immediately below the ejection head 30 (the nozzles N).

An x-axis motor rotation detector 55 is connected to the controller 40. The x-axis motor rotation detector 55 sends a detection signal to the controller 40. In correspondence with the detection signal, the controller 40 determines the rotational direction and the rotation amount of the x-axis motor MX. The movement amount and the movement direction of the substrate stage 23 in direction X are thus correspondingly calculated.

A y-axis motor rotation detector 56 is connected to the controller 40. The y-axis motor rotation detector 56 sends a detection signal to the controller 40. In correspondence with the detection signal, the controller 40 determines the rotational direction and the rotation amount of the y-axis motor MY. The movement amount and the movement direction of the carriage 29 in direction Y are thus correspondingly calculated.

The ejection head driver circuit 57 and a laser head driver circuit 58 are connected to the controller 40.

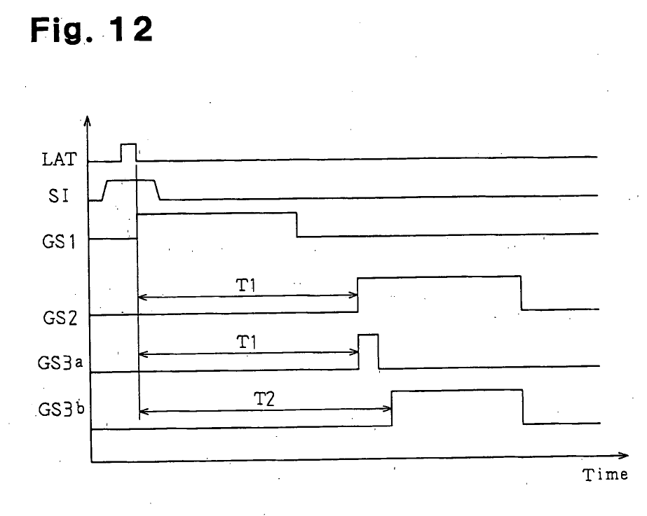

The ejection head driver circuit 57 has the shift register 57a, a latch circuit 57b, a level shifter 57c, and the switch circuit 57d. The controller 40 sends the ejection control data SI to the shift register 57a, synchronously with the latch signal LAT. The shift register 57a converts the ejection control data SI, which is serial data, to 16-bit parallel data corresponding to the sixteen piezoelectric elements PZ (PZ1 to PZ16). The obtained parallel data, or the ejection control data SI, is latched by the latch circuit 57b synchronously with the latch signal LAT of the controller 40. The latched ejection control data SI is then sent to the level shifter 57c and the laser head driver circuit 58 (a delay circuit 58a). The level shifter 57c raises the voltage of the latched ejection control data SI to the drive voltage of the switch circuit 57d, thus producing first open-close signals GS1 (see FIG. 12) corresponding to the piezoelectric elements PZ (PZ1 to PZ16).

The switch circuit 57d includes sixteen switch elements (not shown) corresponding to the piezoelectric elements PZ. The piezoelectric element drive signal COM1 corresponding to the select signal is input to the input of the corresponding switch element. The output of the switch element is connected to the associated piezoelectric element PZ (PZ1 to PZ16). Each switch element of the switch circuit 57d receives the corresponding first open-close signal GS1 from the level shifter 57c. In correspondence with the first open-close signal GS1, it is determined whether the piezoelectric element drive signal COM1 is provided to the associated piezoelectric element PZ.

In other words, in the liquid ejection apparatus 20 of the first embodiment, the piezoelectric element drive signal COM1 is generated by the drive signal generation circuit 44 and sent to the corresponding piezoelectric element PZ. Sending of the piezoelectric element drive signal COM1 is controlled in correspondence with the ejection control data SI (the corresponding first open-close signal GS1) generated by the controller 40. That is, by providing the piezoelectric element drive signal COM1 to the piezoelectric element PZ, the corresponding switch element of which is held in a closed state, the nozzle N corresponding to the piezoelectric element PZ is caused to eject the droplet Fb.

FIG. 12 is a timing chart representing the pulse waveforms of the latch signal LAT, the ejection control data SI, and the first open-close signal GS1.

As illustrated in FIG. 12, in response to the fall of the latch signal LAT, which has been sent to the ejection head driver circuit 57, the first open-close signal GS1 is generated in correspondence with the 16-bit ejection control data SI. When the first open-close signal GS1 rises, the piezoelectric element drive signal COM1 is provided to the corresponding piezoelectric element PZ. The piezoelectric element PZ thus contracts and extends in correspondence with the piezoelectric element drive signal COM1. The droplet Fb is thus ejected from the corresponding nozzle N. When the first open-close signal GS1 falls, ejection of the droplet Fb is ended.

The laser head driver circuit 58 includes the delay circuit 58a, a diffraction element driver circuit 58b, and a switch circuit 58c.

The delay circuit 58a produces pulse signals (a second open-close signal GS2 and a spot formation signal GS3a) each having a predetermined time width. The time width is determined by delaying the latched ejection control data SI, which has been latched by the latch circuit 57b, by the first standby time T1. The delay circuit 58a also generates a pulse signal (a spot switch signal GS3b) having a predetermined time width determined by delaying the latched ejection control data SI by the second standby time T2.

Subsequently, the delay circuit 58a sends the spot formation signal GS3a and the spot switch signal GS3b to the diffraction element driver circuit 58b and the second open-close signal GS2 to the switch circuit 58c.

In response to the spot formation signal GS3a, the diffraction element driver circuit 58b outputs the pinning intensity signal SB1 to the diffraction element 36b. Further, in response to the spot switch signal GS3b, the diffraction element driver circuit 58b sends the drying intensity signal SB2 to the diffraction element 36b. On receiving the spot formation signal GS3a or the spot switch signal GS3b, the diffraction element driver circuit 58b operates the diffraction element 36b for providing the pinning spot B1 or the drying spot B2.

The switch circuit 58c includes sixteen switch elements (not shown) corresponding to the semiconductor lasers L. The laser drive signal COM2, which has been generated by the power supply circuit 45, is input to the input of each of the switch elements. The output of each switch element is connected to the corresponding one of the semiconductor lasers L (L1 to L16). Each switch element of the switch circuit 58c receives the corresponding second open-close signal GS2 from the delay circuit 58a. In correspondence with the second open-close signal GS2, it is determined whether the laser drive signal COM2 must be provided to the corresponding semiconductor laser L.

In other words, in the liquid ejection apparatus 20 of the first embodiment, the laser drive signal COM2 is generated by the supply circuit 45 and sent commonly to the corresponding semiconductor lasers L. Sending of the laser drive signal COM2 is controlled in correspondence with the ejection control data SI (the second open-close signal GS2) that has been produced by the controller 40 (the head driver circuit 57). That is, by providing the laser drive signal COM2 to each of the semiconductor lasers L, the corresponding switch element of which is held in a closed state, the semiconductor laser L is caused to radiate the laser beam B onto the droplet receiving position Pa in correspondence with the pinning intensity signal SB1 or the drying intensity signal SB2.

With reference to FIG. 12, after the latch signal LAT has been input to the ejection head driver circuit 57 and then the first standby time T1 has elapsed, the delay circuit 58a generates the spot formation signal GS3a and the second open-close signal GS2. The spot formation signal GS3a is sent to the diffraction element driver circuit 58b and the second open-close signal GS2 is provided to the switch circuit 58c.

In response to the rise of the spot formation signal GS3a, the diffraction element driver circuit 58b outputs the pinning intensity signal SB1 to the diffraction element 36b. The diffraction element 36b is thus operated in correspondence with the pinning intensity signal SB1. In response to the second open-close signal GS2, the switch circuit 58c provides the laser drive signal COM2 to the corresponding semiconductor laser L. This causes the semiconductor laser L to radiate the laser beam B.

Therefore, after the first standby time has elapsed, or when the outer diameters of the droplets Fb have reached the radiation diameter Ra, the pinning spots B1 are simultaneously provided to the droplets Fb.

After the second standby time T2 has elapsed, the delay circuit 58a generates the spot switch signal GS3b and provides the spot switch signal GS3b to the diffraction element driver circuit 58b. In response to the rise of the spot switch signal GS3b, the diffraction element driver circuit 58b outputs the drying intensity signal SB2 to the diffraction element 36b.

Thus, after the second standby time T2 has elapsed, the droplets Fb that have been subjected to pinning are simultaneously irradiated by the laser beams B defining the drying spots B2.

Subsequently, the second open-close signal GS2 falls and sending of the laser driver signal COM2 is thus suspended. Accordingly, the drying and baking procedure by the semiconductor lasers L is ended.

A method for forming the identification code 10 using the liquid ejection apparatus 20 will hereafter be explained.

First, as shown in FIG. 5, the substrate 2 is mounted on the substrate stage 23 that is located at the proceed position, with the backside 2b of the substrate 2 facing upward. In this state, the substrate 2 is arranged forward from the guide member 26 with respect to direction X. The carriage 29 (the ejection head 30) is moved to an intermediate portion of the guide member 26 in such a manner that the code formation area S of the substrate 2 passes immediately below the carriage 29.

The controller 40 then activates the x-axis motor MX, thus transporting the substrate 2 at the transport speed Vx in direction X by means of the substrate stage 23. When the substrate detector 54 detects the end of the substrate 2, a detection signal is sent from the y-axis motor rotation detector 56 to the controller 40. The controller 40 then determines whether the central portions of the cells C (the black cells C1) of the first column have reached the corresponding droplet receiving positions Pa, in correspondence with the detection signal.

Meanwhile, the controller 40 operates in accordance with the code formation program. Specifically, the ejection control data SI based on the bit map data BMD stored in the RAM 42 and the piezoelectric element drive signal COM1, which has been generated by the drive signal generation circuit 44, are sent to the ejection head driver circuit 57. Further, the laser drive signal COM2, which has been produced by the power supply circuit 45, is provided to the laser head driver circuit 58. The control section 41 then stands by till it is time to send the latch signal LAT to the ejection head driver circuit 57.

When the first column of the cells C (the black cells C1) reaches the droplet receiving positions Pa, the controller 40 suspends transport of the substrate 2 through the x-axis motor driver circuit 52. The latch signal LAT is then output to the ejection head driver circuit 57. In response to the latch signal LAT, the ejection head driver circuit 57 generates the first open-close signal GS1 in accordance with the ejection control data SI. The first open-close signal GS1 is then sent to the switch circuit 57d. In this manner, the piezoelectric element drive signal COM1 is provided to the piezoelectric elements PZ, the corresponding switch elements of which is held in a closed state, in correspondence with the selection signal SEL. This causes simultaneous ejection of the droplets Fb from the corresponding nozzles N. The droplets Fb are then received by the corresponding black cells C1.

After the latch signal LAT has been sent to the ejection head driver circuit 57, the laser head driver circuit 58 (the delay circuit 58a) receives the ejection control data SI from the latch circuit 57b. In correspondence with the ejection control data SI, the laser head driver circuit 58 starts generating the spot formation signal GS3a, the spot switch signal GS3b, and the second open-close signal GS2. The laser head driver circuit 58 then stands by till the spot formation signal GS3a, the spot switch signal GS3b, and the second open-close signal GS2 are each output to the corresponding one of the diffraction element driver circuit 58b and the switch circuit 58c.

The laser head driver circuit 58 sends the spot formation signal GS3a to the diffraction element driver circuit 58b and the second open-close signal GS2 to the switch circuit 58c after the first standby time T1 has elapsed since starting of the liquid ejection through the piezoelectric elements PZ, or outputting of the latch signal LAT from the controller 40.

In response to the spot formation signal GS3a, the diffraction element driver circuit 58b outputs the pinning intensity signal SB1 to the diffraction element 36b and thus activates the diffraction element 36b. In response to the second open-close signal GS2, the switch circuit 58c provides the laser drive signal COM2 to each of the semiconductor lasers L, the corresponding switch element of which is held in a closed state. The semiconductor lasers L are thus permitted to simultaneously radiate the laser beams B.

By the time the first standby time T1 elapses, the droplets Fb have spread wet in the corresponding black cells C1 to the extent at which the outer diameter of each of the droplets Fb reaches the radiation diameter Re.

Therefore, the pinning spot B1 is provided to each droplet Fb at the corresponding droplet receiving position Pa, when the outer diameter of the droplet Fb coincides with the radiation diameter Re. The suppressing portions Fb1 of the droplet Fb thus prevent the droplet Fb from further spreading beyond the corresponding black cell C1. The droplet Fb is thus pinned to the black cell C1.

The laser head driver circuit 58 outputs the spot switch signal GS3b to the diffraction element driver circuit 58b after the second standby time T2 has elapsed since outputting of the latch signal LAT from the controller 40.

In response to the spot switch signal GS3b, the diffraction element driver circuit 58b sends the drying intensity signal SB2 to the diffraction element 36b and thus operates the diffraction element 36b in correspondence with the drying intensity signal SB2.

By the time the second standby time elapses, the projected portions Fb2 of each droplet Fb spread to reach the outline of the corresponding black cell C1 in the vicinity of the corresponding corners of the black cell C1.

Therefore, each droplet Fb is irradiated with the laser beam B defining the drying spot B2 when the projected portions Fb2 of the droplet Fb corresponds to the outline of the black cell C1. The droplet Fb is thus dried and baked in the state filling the black cell C1. Accordingly, a first column of the dots D is defined in such a manner that each dot D of the column is shaped in correspondence with the outline of the black cell C1.

Afterwards, every time each of the following columns of the cells C reaches the droplet receiving positions Pa, the controller 40 operates to eject the droplets Fb simultaneously from the corresponding nozzles N onto the black cells C1. After the first standby time T1 has elapsed, the pinning spot B1 is provided to each of the droplets Fb. After the second standby time T2 has elapsed, the drying spot B2 is provided to the droplet Fb.

When formation of the identification code 10 is completed, the controller 40 operates the x-axis motor MX to move the substrate 2 from below the ejection head 30.

The first embodiment has the following advantages.

(1) When the outer diameter of each droplet Fb at the droplet receiving position increases to the radiation diameter Re, which is slightly smaller than the cell size Ra, the corresponding semiconductor laser L radiates the laser beam B defining the cross-shaped pinning spot B1 onto the droplet Fb. The pinning spot B1 includes the belt-like section extending in direction X and the belt-like section extending in direction Y, which are provided in an area corresponding to the droplet receiving position Pa. Each of the belt-like sections is slightly longer than the cell size Ra.

The pinning spot B1 thus dries and fixes the suppressing portions Fb1 and the radiated portions Fs1 of the droplet Fb. In this state, the suppressing portions Fb1 prevent the droplet Fb from spreading radially outward. The droplet Fb is thus pinned in the corresponding black cell C1.

Accordingly, the dot D is prevented from spreading beyond the corresponding black cell C1.

(2) The laser beam B defining the drying spot B2 is radiated onto the droplet receiving position Pa. The drying spot B2 has a substantially rectangular shape and covers the corresponding cell C (black cell C1) as a whole. The drying spot B2 is provided to the droplet Fb after the droplet Fb has been pinned in the black cell C1 and the projected portions Fb2 of the droplet Fb have reached the outline of the black cell C1 in the vicinity of the corresponding corners of the black cell C1.

The droplet Fb is thus entirely dried and baked at timings that allow the droplet Fb to be shaped in correspondence with the outline of the black cell C1. This provides the dot D having a shape corresponding to the outline of the black cell C1.

(3) The diffraction element 36b is operated in correspondence with the pinning intensity signal SB1 and the drying intensity signal SB2. Formation of the pinning spot B1 and the drying spot B2 is thus dynamically performed. That is, pinning and drying of the droplets Fb are performed at desired timings. The shape of each droplet Fb is thus adjusted with improved accuracy.

(4) In the first embodiment, the pinning spot B1 and the drying spot B2 are provided by the laser beam B radiated by each of the semiconductor lasers L. The pinning spot B1 and the drying spot B2 are thus formed with increased accuracy by the light having the wavelength that satisfies the conditions for drying and baking the droplet Fb. This enhances accuracy for forming the dots D, each of which is shaped in correspondence with the outline of the black cell C1.

Next, a second embodiment of the present invention will be explained with reference to FIGS. 13 to 16. In the second embodiment, the laser head 36 includes a modified optical system.

As shown in FIG. 13, the laser head 36 includes a cylindrical lens 61, a polygon mirror 62, and a scanning lens 63, in addition to the semiconductor laser array LD, the collimator 36a, and the diffraction element 36b. The polygon mirror 62 functions as a beam scanning portion. In FIG. 13, the rotational angle θp of the polygon mirror 62 is zero degrees.

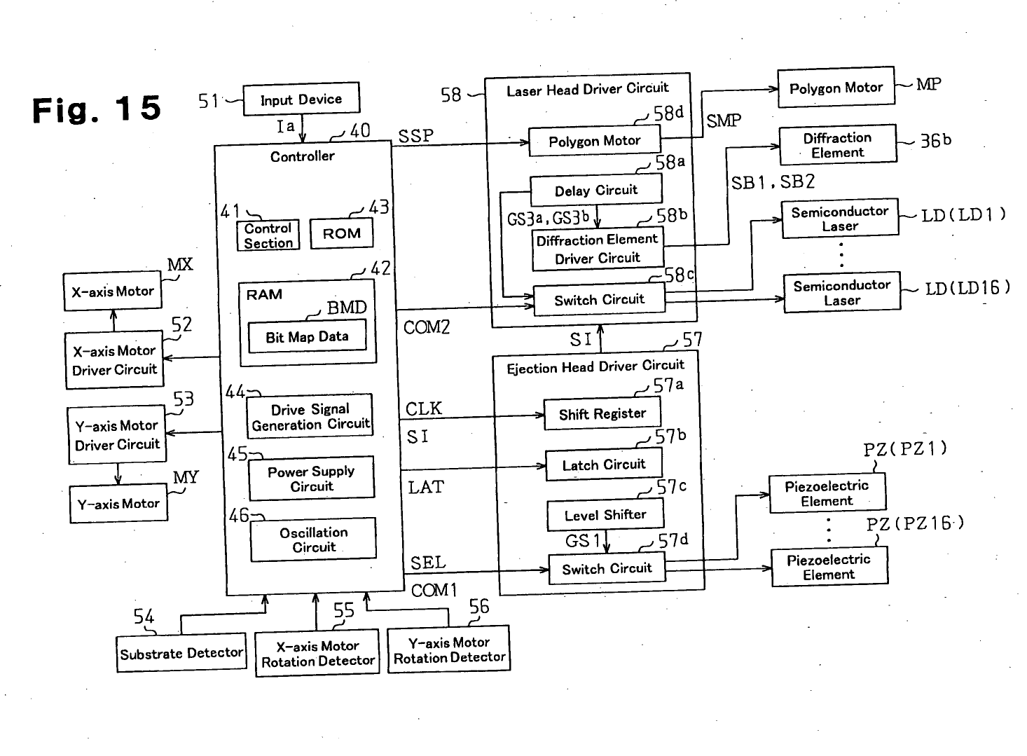

The cylindrical lens 61 has only one curved surface and performs “optical face tangle error correction” for the polygon mirror 62. The cylindrical lens 61 introduces the laser beam B to the polygon mirror 62. The polygon mirror 62 is a regular triacontakaihexagon (thirty-six-sided polygon) mirror and defines thirty six reflective surfaces M. The reflective surfaces M are rotated by a polygon motor MP (see FIG. 15) in direction R indicated by the arrow of FIG. 13 (clockwise). That is, the reflective surfaces M into which the laser beam B is introduced are switched from one to another, every time the rotational angle θp is advanced by 10 degrees in direction R. After having been reflected by the polygon mirror 62, the laser beam B is radiated onto the backside 2b of the substrate 2. The scanning lens 63 is defined by an f-theta lens that ensures a constant scanning speed of the laser beam B on the substrate 2. The image height Y of the f-theta lens varies proportionally to the light incidence angle θ and, if the focal length of the f-theta lens is defined as “f”, satisfies the following equation: Y=fθ. The f-theta lens facilitates constant speed scanning.

As illustrated in FIG. 13, the laser beam B is reflected by an end of one of the reflective surface M (Ma) located forward with respect to direction R. The laser beam B is then deflected at a deflection angle θ1 to the side opposite to the semiconductor laser L with respect to an optical axis 63A of the scanning lens 63. In the second embodiment, the deflection angle θ1 is five degrees.

The cylindrical lens 61 adjusts the optical axis of the laser beam B with respect to a direction perpendicular to the sheet of FIG. 13. The laser beam B is then introduced into the polygon mirror 62. When the rotational angle θp of the polygon mirror 62 is zero degrees, the reflective surface Ma of the polygon mirror 62 deflects the laser beam B at the deflection angle θ1 to a side opposite to the semiconductor laser L with respect to the optical axis 63A. The laser beam B is thus sent to the backside 2b of the substrate 2 through the scanning lens 63.

The radiating position of the laser beam B on the backside 2b of the substrate 2 when the rotational angle θp of the polygon mirror 62 is zero degrees is defined as a radiation start position Pe1. The radiation start position Pe1 is spaced from the corresponding droplet receiving position Pa in direction X by a predetermined distance. The distance is set in such a manner that the outer diameter of the droplet Fb received by the substrate 2 coincides with the radiation diameter Re at the radiation start position Pe1.

Accordingly, as illustrated in FIG. 13, when the rotational angle θp of the polygon mirror 62 is zero degrees, the laser beam B defining the pinning spot B1 reflected by the reflective surface Ma is radiated onto the droplet Fb, the outer diameter of which coincides with the radiation diameter Re, at the radiation start position Pe1.

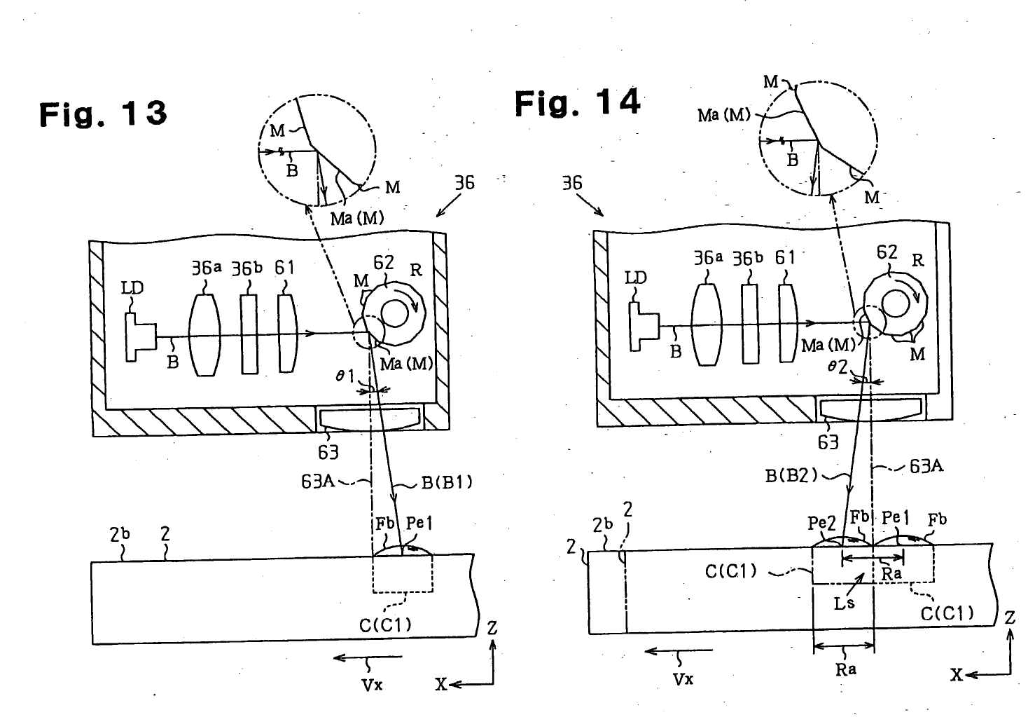

As illustrated in FIG. 14, if the polygon mirror 62 is rotated in direction R at the rotational angle θp of substantially ten degrees, the end of the reflective surface Ma located rearward in direction R reflects the laser beam B at a deflection angle θ2 (θ2=−5 degrees) with respect to the optical axis 63A. The laser beam B then passes through the scanning lens 63 and reaches the backside 2b of the substrate 2.

In the second embodiment, the radiating position of the laser beam B on the backside 2b of the substrate 2 when the rotational angle θp of the polygon mirror 62 is 10 degrees is defined as a radiation end position Pe2. The area between the radiation end position Pe2 and the radiation start position Pe1 is defined as a scanning area Ls. The dimension of the scanning area Ls in direction X, which is a scanning dimension, is set to the value equal to the cell size Ra.

In other words, through deflection and reflection of the laser beam B by the polygon mirror 62, the laser head 36 performs scanning by the laser beam B (each defining the beam spots) for each of the cells C (in accordance with the cell size Ra). That is, the polygon mirror 62 moves the laser beam B from the radiation start position Pe1 to the radiation end position Pe2.

The transport speed Vx of the substrate stage 23 (the black cells C1) is set in such a manner that the central portion of each black cell C1 shifts from the radiation start position Pe1 to the radiation end position Pe2 in a single radiation cycle of the laser beam B defining each beam spot. The transport speed Vx is also set in such a manner that the second standby time T2 elapses while the droplet Fb is moving in the scanning area Ls. After the second standby time T2 has elapsed, the laser beam B defining the drying spot B2 is radiated.

That is, radiation of the laser beam B is performed for each of the cells C when the droplets Fb move in the scanning area Ls. The droplet Fb is thus irradiated sequentially with the laser beam B defining the pinning spot B1 and the laser beam B defining the drying spot B2, which are maintained stationary relative to the droplet Fb.

The electric configuration of the liquid ejection apparatus 20, which is constructed as above-described, will hereafter be explained with reference to FIG. 15.

The laser head driver circuit 58 includes a polygon driver circuit 58d. The controller 40 sends a polygon start signal SSP to the polygon driver circuit 58d. In response to the polygon start signal SSP, the polygon driver circuit 58d provides a polygon drive signal SMP to the polygon motor MP, thus actuating the polygon motor MP.

In response to the detection signal of the substrate detector 54, the controller 40 starts the polygon motor MP. Specifically, the controller 40 sends the polygon start signal SSP to the laser head driver circuit 58 in such a manner that the rotational angle θp of the polygon mirror 62 becomes zero degrees when the central portion of each black cell C1 of the first column is located at the corresponding radiation start position Pe1.

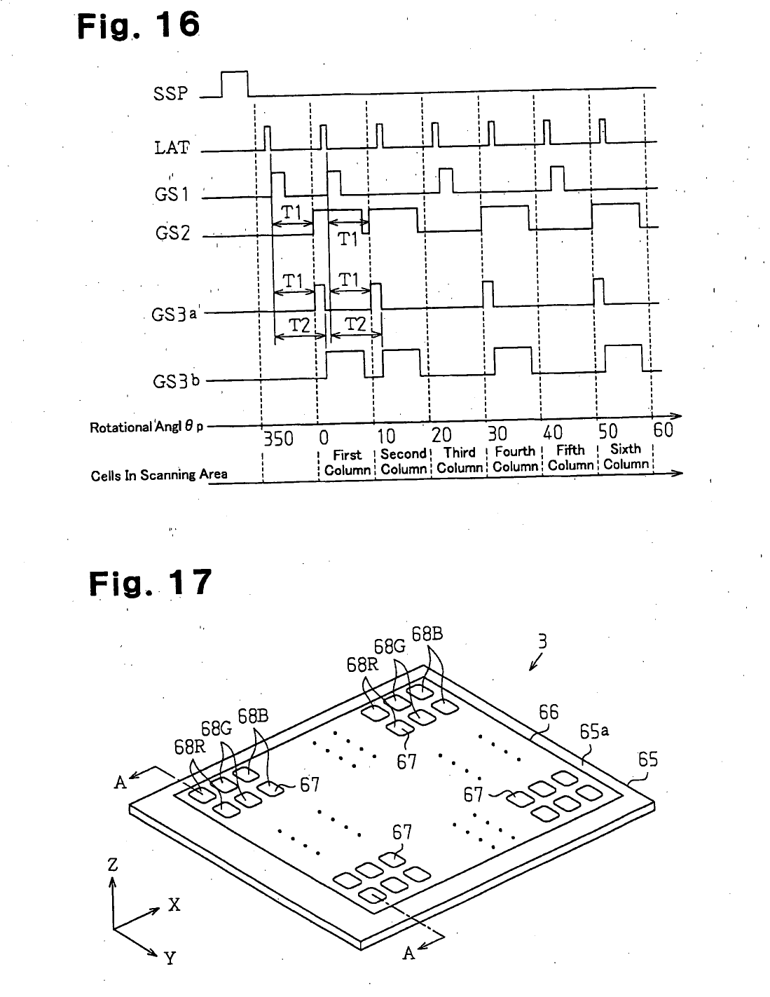

FIG. 16 is a timing chart representing generation of the polygon start signal SSP, the latch signal LAT, the first open-close signal GS1, the second open-close signal GS2, the spot formation signal GS3a, and the spot switch signal GS3b with respect to the rotational angle θp of the polygon mirror 62 and the column numbers of the cells C located in the scanning area Ls. In FIG. 16, the cells C of the first, second, fourth, and sixth columns correspond to the black cells C1. The cells C of the third and fifth columns correspond to the blank cells C0.

When the substrate detector 54 detects the end of the substrate 2 moving at the transport speed Vx, the controller 40 generates the polygon start signal SSP at a predetermined timing as illustrated in FIG. 16. In response to the rise of the polygon start signal SSP, the polygon driver circuit 58d produces the polygon drive signal SMP. In response to the polygon drive signal SMP, the polygon mirror 62 starts to rotate in direction R. In this manner, the rotational angle θp of the polygon mirror 62 becomes zero degrees when the central portions of the black cells C1 of the first column reach the corresponding radiation start positions Pe1.

When the first column of the cells C (the black cells C1) reach the droplet receiving positions Pa, the latch signal LAT falls, as in the first embodiment. In response to the fall of the latch signal LAT, the first open-close signals GS1 are generated, thus causing the corresponding nozzles N to simultaneously eject the droplets Fb. The droplets Fb are simultaneously received by the black cells C1 of the first column.

After the first standby time Ta has elapsed since the fall of the latch signal LAT (starting of the liquid ejection onto the black cells C1 of the first column), the outer diameter of each of the droplets Fb coincides with the radiation diameter Re and the droplets Fb reach the corresponding radiation start positions Pe1. In other words, the central portions of the black cells C1 of the first column enter the scanning area Ls. At this stage, the laser head driver circuit 58 generates the open-close signals GS2 and the spot formation signals GS3a. In response to the rises of the second open-close signal GS2s and the spot formation signals GS3a, the laser beams B defining the pinning spots B1 are simultaneously radiated from the corresponding radiation ports 37.

At this point, referring to FIG. 16, the rotational angle θp of the polygon mirror 62 is zero degrees. The pinning spots B1 are thus provided to the droplets Fb that are located at the corresponding radiation start positions Pe1.

That is, while moving in the scanning area Ls, the droplets Fb are scanned by the laser beams B defining the pinning spots B1, which are maintained stationary relative to the droplets Fb.

After the second standby time T2 has elapsed since the fall of the latch signal LAT, the laser head driver circuit 58 generates the spot switch signal GS3b. In response to the rise of the spot switch signal GS3b, each pinning spot B1 is switched to the drying spot B2.

Thus, while moving at the transport speed Vx, the droplets Fb are scanned by the laser beams B that define the pinning spots B1 and the drying spots B2, which are maintained stationary relative to the droplets Fb. Accordingly, the dots D of the first column are provided in shapes corresponding to the outlines of the black cells C1.

Afterwards, the second open-close signals GS2 fall and thus radiation of the laser beams B by the semiconductor lasers L is stopped. This completes the drying and baking procedure on the droplets Fb of the first column.

Subsequently, after liquid ejection onto the black cells C1 of the second column has started and then the first standby time T1 has elapsed, the central portions of the black cells C1 of the second column enter the scanning area Ls while the central portions of the black cells C1 of the first column separate from the scanning area Ls. The laser head driver circuit 58 then generates the second open-close signals GS2 and the spot formation signals GS3a. In response to the rises of the second open-close signals GS2 and the spot formation signals GS3a, the laser beams B defining the pinning sports B1 are simultaneously radiated from the corresponding radiation ports 37.

In this state, referring to FIG. 16, the rotational angle θp of the polygon mirror 62 is ten degrees. Thus, the pining spots B1 are provided to the droplets Fb of the second column that are located at the corresponding radiation start positions Pe1.

Afterwards, the droplets Fb received by the cells C (the black cells C1) of the following columns successively move in the scanning area Ls. In the scanning area Ls, the droplets Fb are irradiated by the laser beams B defining the pinning spots B1 and the drying spots B2, which are maintained stationary relative to the droplets Fb. Accordingly, the dots D having shapes corresponding to the outlines of the black cells C1 are provided.

The second embodiment has the following advantages.

(5) While being transported, the droplets Fb are irradiated by the laser beams B that define the pinning spots B1 and the drying spots B2, which are maintained stationary relative to the droplets Fb. This provides the dots D that are shaped in correspondence with the outlines of the black cells C1. This improves productivity for forming the identification code 10.

(6) Each pinning spot B1 is dynamically switched to the drying spot B2 in response to the spot switch signal GS3b. Thus, switching between the two types of spots is performed at a desirable timing regardless of the transport speed Vx of the substrate 2. Accordingly, the pinning spot B1 is reliably switched to the drying spot B2 in correspondence with changes in the shape of the droplet Fb that has been received by the substrate 2. The shape of each dot D is thus adjusted with improved accuracy.

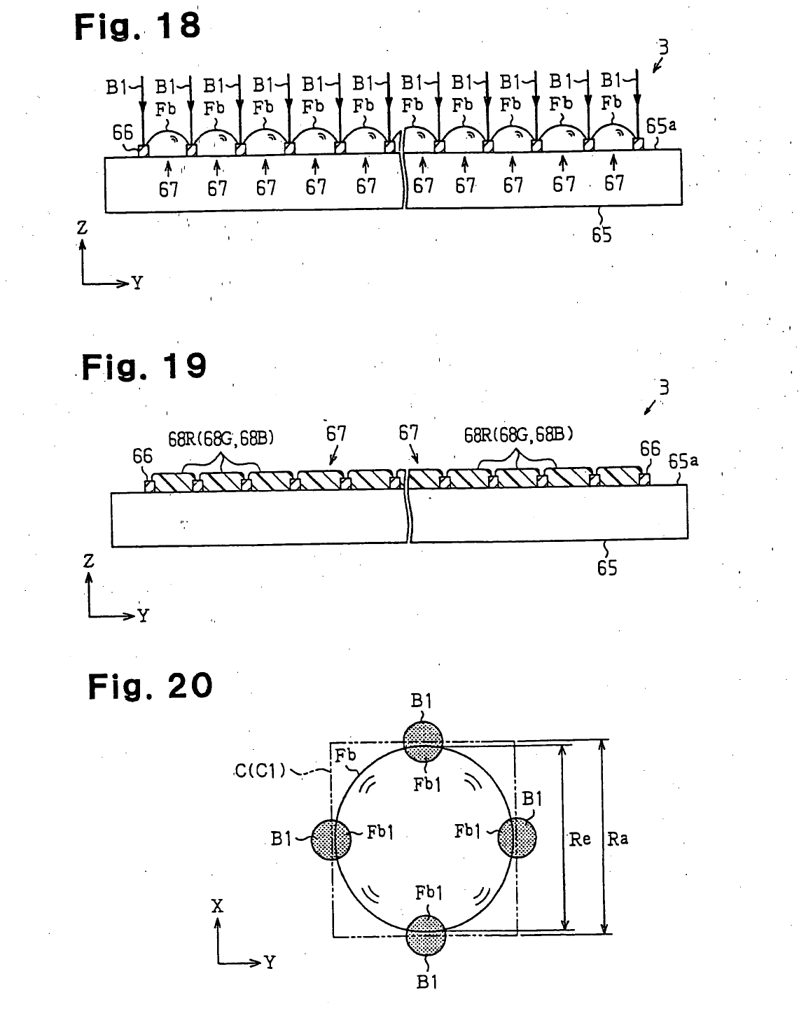

A third embodiment of the present invention will hereafter be explained with reference to FIGS. 17 to 19. In the third embodiment, the identification code is replaced by a color layer defined in the color filter substrate 3. In the following, the color filter substrate 3 will be described in detail. FIG. 17 is a perspective view showing the color filter substrate 3 and FIG. 18 is a view for explaining a procedure for manufacturing the color filter substrate 3. FIG. 19 is a cross-sectional view taken along line A-A of FIG. 17.

As shown in FIG. 17, the color filter substrate 3 includes a rectangular transparent glass substrate 65 formed of non-alkaline glass. The glass substrate 65 has a color layer forming surface 65a that faces the substrate 2. A light shielding layer 66 is defined on the color layer forming surface 65a. The light shielding layer 66 is formed of resin containing light shielding material such as chrome and carbon black. The light shielding layer 66 has a grid-like shape defined on an x-y plane.

A plurality of color layer formation areas 67 are defined on the grid-like light shielding layer 66. The color layer formation areas 67 each have a rectangular shape and are aligned in a matrix-like manner entirely on the surface of the color layer forming surface 65a.

Using the liquid ejection apparatus 20, a corresponding one of red color layers 68R, green color layers 68G, and blue color layers 68D is formed in each of the color layer formation areas 67.

Specifically, as illustrated in FIG. 18, so as to form the red, green, and blue color layers 68R, 68G, 68B, the droplets Fb each containing a corresponding color layer forming material are ejected onto the corresponding color layer formation areas 67. After having been received by the color layer forming surface 65a, the droplets Fb are irradiated with the laser beams B defining the pinning spots B1 and then the drying spots B2.

Referring to FIG. 19, the thickness of each of the red, green, and blue color layers 68R, 68G, 68B is greater than the thickness of the light shielding layer 66 (as measured in direction Z). The red, green, and blue color layers 68R, 68G, 68B are formed in the corresponding color layer formation areas 67 without spreading beyond the color layer formation areas 67. That is, the colors of the color layers 68R, 68G, 68B are prevented from mixing with each other.

The third embodiment has the following advantage.

(7) In the third embodiment, the red, green, and blue color layers 68R, 68G, 68B are formed as shaped in correspondence with the outlines of the color layer formation areas 67. It is thus unnecessary to separately provide a wall that encompasses each droplet Fb received by the color layer forming surface 65a in order to prevent the droplet Fb from spreading beyond the corresponding color layer-formation area 67.

The illustrated embodiments may be modified as follows.

The shape of the pinning spot B1 is not restricted to that of the illustrated embodiments, or the crossed shape. For example, as shown in FIG. 20, the pinning spot B1 may include a plurality of circular sections that are provided only in correspondence with the suppressing portions Fb1. Alternatively, the pinning spot B1 may have a rectangular shape corresponding to the outline of the black cell C1 or the color layer formation area 67.

In the illustrated embodiments, the outer diameter of each droplet Fb increases after the droplet Fb has reached the corresponding droplet receiving position Pa. When the outer diameter of the droplet Fb reaches the radiation diameter Re, the pinning spot B1 is provided to the droplet Fb. However, the timing for providing the pinning spot B1 is not restricted to this. For example, the pinning spot B1 may be provided to the droplet Fb before the outer diameter of the droplet Fb becomes the radiation diameter Re. Alternatively, radiation of the pinning spot B1 may be performed when the outer diameter of the droplet Fb coincides with the cell size Ra. In other words, the pinning spot B1 may be provided at any suitable timing as long as the outline of the droplet Fb is contained in the corresponding cell C (black cell C1).

In the illustrated embodiments, the pinning spot B1 and the drying spot B2 are provided through the diffraction element 36b, which is electrically or mechanically driven. However, the diffraction element 36b may be replaced by a diffraction grating, a mask, or a branching element.

In the illustrated embodiments, the drying spot B2 is provided after the pinning spot B1. However, a laser beam in which the pinning spot B1 is superimposed on the drying spot B2 may be employed as the laser beam B, so that the pinning and the drying are simultaneously achieved.

In the first embodiment, the laser beam B defining the pinning spot B1 and the drying spot B2 is radiated onto the corresponding droplet receiving position Pa. However, the pinning spot B1 and the drying spot B2 may be provided to a position located forward from the droplet receiving position Pa with respect to direction X, in such a manner that the droplet Fb is irradiated with the laser beam B defining the pinning spot B1 during the first standby time T1. In this case, the droplet Fb is irradiated with the laser beam B defining the drying spot B2 during the second standby time T2.

In the first and second embodiments, each of the dots D has a square shape as viewed from above. However, the shape of dot D is not restricted to this but may be modified to, for example, an oval shape or a linear shape like a bar of a bar code.

In the second embodiment, the optical system for providing the laser beams B is defined by the polygon mirror 62. However, a galvanometer mirror may be employed as the optical scanning system. The galvanometer mirror is a deflector including a mirror to which a shaft is secured. The rotational angle of the mirror is changeable in accordance with an electric signal.

In the illustrated embodiments, the laser radiating portion is defined by each of the semiconductor lasers L. However, the semiconductor lasers L may be replaced by carbonate gas lasers or YAG lasers. That is, the laser radiating portion may be defined by any suitable laser as long as the laser beam radiated by the laser onto each of the black cells C1 has a wavelength that permits drying or baking of the droplet Fb.

In the illustrated embodiments, the laser beam B is employed as the energy beam. However, an incoherent light, an ion beam, a plasma light, or an electron beam may be selected as the energy beam instead of the laser beam B. That is, any suitable energy beam may be employed as long as the energy beam is capable of drying or baking the droplet Fb in the black cell C1.

In the illustrated embodiments, the semiconductor lasers L are provided by the quantity corresponding to the quantity of the nozzles N. However, a laser light source may radiate a single laser beam B that is branched to sixteen braches by a branching element such as a diffraction element.

In the illustrated embodiments, the dots D of the identification code 10 and the color layers 68R, 68G, 68B of the color filter substrate 3 are formed by the liquid ejection apparatus 20. However, the liquid ejection apparatus 20 may be used for forming a dot on an insulating film or a metal wiring. Also in these cases, the shape of the dot is adjusted in the same manner as the illustrated embodiments.

In the illustrated embodiments, the electro-optic device is defined as the liquid crystal display having the dots D or the color layers. However, the electro-optic device may be embodied as an electroluminescence display. In this case, the droplet Fb must contain material for forming a light emission element. Since the shape of the light emission element is adjusted in the same manner as the illustrated embodiments, productivity for forming the electroluminescence display is enhanced.

In the illustrated embodiments, the identification code 10 of the liquid crystal display module 1 is formed according to the present invention. However, a display module of, for example, an organic electroluminescence display may be provided. Alternatively, a display module having a field effect type device (an FED or SED) may be formed. Such device emits light from a fluorescent substance using electrons emitted by a flat electron emission element.

The present examples and embodiments are to be considered as illustrative and not restrictive and the invention is not to be limited to the details given herein, but may be modified within the scope and equivalence of the appended claims.

1. A liquid ejection apparatus comprising:
an ejecting portion that ejects a liquid droplet containing a dot forming material onto a dot forming section defined on an ejection target surface; and
a radiating portion that radiates an energy beam onto the ejection target surface for at least partially suppressing spreading of the liquid droplet in a wet state after the droplet has been received by the dot forming section.

2. The apparatus according to claim 1, wherein:
the dot forming section is defined by an outline;
the energy beam is radiated onto a portion of the liquid droplet that approaches the outline of the dot forming section earlier than the remainder of the droplet while spreading wet in the dot forming section.

3. The apparatus according to claim 2, wherein the dot forming section has a rectangular shape, the energy beam being radiated onto a middle portion of each side of the rectangular shape.

4. The apparatus according to claim 3, wherein the energy beam defines a cross-shaped cross section.

5. The apparatus according to claim 1, wherein the dot forming section has a rectangular shape, the energy beam being radiated onto at least one of the sides of the rectangular shape.

6. The apparatus according to claim 1, wherein the energy beam is formed by a light.

7. The apparatus according to claim 1, wherein the energy beam is defined by a coherent light.

8. The apparatus according to claim 1, wherein:
the energy beam is a first energy beam; and
the radiating portion radiates a second energy beam onto the liquid droplet for drying the liquid droplet.

9. The apparatus according to claim 8, wherein the second energy beam entirely covers the dot forming section.

10. The apparatus according to claim 1, wherein:
the energy beam is a first energy beam;
the dot forming section is defined by an outline;
the first energy beam is radiated onto a plurality of portions of the liquid droplet that approach the outline of the dot forming section earlier than the remainder of the droplet while spreading wet in the dot forming section; and
a second energy beam is radiated onto the liquid droplet for drying the droplet when a portion intermediate between adjacent ones of the plurality of portions approaches the outline of the dot forming section.

11. The apparatus according to claim 3, wherein:
the energy beam is a first energy beam; and
the radiating portion radiates a second energy beam onto the liquid droplet for drying the droplet when the liquid droplet spreads to positions close to the corners of the rectangular shape.

12. The apparatus according to claim 1, wherein:
the dot forming section is movable relative to the ejecting portion; and
the apparatus further comprises a scanning portion that scans the energy beam that is maintained stationary relative to the droplet, thereby radiating the energy beam onto the liquid droplet in the dot forming section.

13. The apparatus according to claim 12, wherein the scanning portion includes a polygon mirror that is rotated in correspondence with movement of the dot forming section.

14. The apparatus according to claim 1, wherein the ejection target surface is lyophilic to the liquid droplet.

15. A method for forming a dot, comprising:
ejecting a liquid droplet containing a dot forming material to an ejection target surface;
radiating an energy beam onto the ejection target surface for at least partially suppressing spreading of the liquid droplet in a wet state on the ejection target surface; and
forming a dot by drying the liquid droplet on the ejection target surface.

16. The method according to claim 15, wherein the energy beam is radiated onto the ejection target surface before the liquid droplet is ejected onto the ejection target surface.

17. The method according to claim 15, wherein:
the energy beam is a first energy beam; and
the method further comprises radiating a second energy beam onto the liquid droplet for drying the droplet after radiation of the first energy beam.

18. The method according to claim 15, wherein:
the ejection target surface is defined on a substrate, a code formation area being defined on the ejection target surface, the liquid droplet being ejected onto a data cell selected from a plurality of data cells that are defined by dividing the code formation area;
the energy beam is radiated onto the selected data cell for suppressing spreading of the liquid droplet in a wet state beyond the data cell;
the dot is one of a plurality of dots each formed in one of the data cells; and
an identification code is formed in the code formation area by providing the dots.

19. The method according to claim 15, wherein:
the dot forming material is a color layer forming material, the ejection target surface being defined on a substrate, a plurality of color layer formation areas being defined on the ejection target surface, the liquid droplet being one of a plurality of liquid droplets each ejected onto one of the color layer formation areas;
the energy beam is radiated onto each color layer formation area for suppressing spreading of the liquid droplet in a wet state beyond the color layer formation area; and
a plurality of color layers are defined on the substrate by providing the dot in each color layer formation area.

20. The method according to claim 15, wherein:
the dot forming material is a material for forming a light emission layer in an electro-optic device, the ejection target surface being defined on a substrate of the electro-optic device, a plurality of light emission layer forming sections being defined on the ejection target surface, the liquid droplet being one of a plurality of liquid droplets each ejected onto one of the light emission layer forming sections;
the energy beam is radiated onto each light emission layer forming section for suppressing spreading of the liquid droplet in a wet state beyond the light emission layer forming section; and
a plurality of light emission layers are formed on the substrate by providing the dot in each light emission layer forming section.
